(19) United States
(12) Patent Application Publication
(10) Pub. No.: US 2008/0267568 A1
(43) Pub. Date: Oct. 30, 2008

(54) Method and apparatus for performing a compression splice

(76) Inventor: David Lee Dean, Hickory, NC (US)

Correspondence Address: CORNING INCORPORATED, INTELLECTUAL PROPERTY DEPARTMENT, SP-TI-3-1, CORNING, NY, 14831, US

(21) Appl. No.: 11/799,005

(22) Filed: Apr. 30, 2007

(51) Int. Cl. G02B 6/255

(52) U.S. Cl. 385/96

(57) ABSTRACT

A method for compression splicing optical fibers comprising providing first and second optical fibers, providing a deformable splice tube, heating the deformable splice tube with a heat source, inserting the optical fibers into the heated splice tube until they contact, and applying compression to the heated splice tube to deform the splice tube and maintain their ends in contact. An apparatus for compression splicing optical fibers comprising a deformable splice tube, a compression device and a heat source coupled to the deformable splice tube through the compression device.

### BACKGROUND OF THE INVENTION

1. Field of the Invention

The present invention relates generally to methods and apparatus for joining optical fibers, and more particularly, to methods and apparatus for splicing optical fibers together by compression.

2. Technical Background

Optical fibers are increasingly being used for a variety of broadband applications, including voice, video, and data transmission applications. As a result, network providers have begun to develop fiber optic communications networks to deliver “fiber-to-the-curb” (FTTC), “fiber-to-the-business” (FTTB), “fiber-to-the-premises” (FTTP), and “fiber-to-the-home” (FTTH), collectively referred to generically herein as “FTTx.” In this regard, splicing optical fibers is often required to create a continuous optical path for transmission. Communication service providers typically utilize two methods for splicing, fusion and mechanical splicing.

Fusion splicing typically involves aligning and then fusing together two stripped, cleaned and cleaved optical fibers with an electric arc, laser or other heat source. Disadvantageously, fusion splicing is often difficult to perform in the field, requires costly fusion splicing equipment, and requires the expertise of a skilled technician. Mechanical splicing typically involves some form of assembly for mechanically maintaining the fibers in contact, such as various field-installable connectors available from Corning Cable Systems of Hickory, N.C. As mechanical splicing does not result in fiber cores being fused, it is oftentimes reversible without destruction. Many conventional mechanical splice connectors typically include a crimp or other structure for retaining a field fiber within a connector. Mechanical splice connectors require a balance between applying enough force/load to secure and align the optical fibers versus overloading and damaging the fibers.

While fusion and mechanical splicing are suitable splicing techniques, it would be desirable to splice optical fibers using other methods. In the past, splicing by other methods has been limited by the physical and performance characteristics of optical fibers. For example, conventional optical fibers have limited environmental properties (e.g., thermal cycling from −40 to +80 C°). Further, conventional optical fibers have limited bend capabilities. Recently, however, optical fiber technology has evolved to provide optical fibers that provide increased tolerance ranges for splicing, thus making it easier to balance the loads placed upon the fibers during the splicing process. This, in turn, has provided communication providers with the ability to apply a wider margin of force to the fibers to secure them together.

Accordingly, communication service providers are looking to utilize improved optical fiber technology by developing new solutions for handling optical fibers. In this regard, it would be desirable to provide new methods and apparatus for splicing optical fibers.

### SUMMARY OF THE INVENTION

To achieve the foregoing and other objects, and in accordance with the purposes of the invention as embodied and broadly described herein, the present invention provides methods for splicing optical fibers by compression. The present invention further provides embodiments of compression splice structure.

In one embodiment, a crimping device including at least one splice tube is provided. Crimp dies are attached to a support block and a corresponding press block. Each crimp die is provided with an alignment feature for maintaining the splice tubes in a predetermined orientation and spacing. The crimp dies are generally rectangular and elongated. Leads are formed along selected sides of at least two of the crimp dies for permitting a heat source to be connected. The alignment feature is located substantially intermediate the crimp dies and extends along the surface. The alignment feature may include grooves or channels for receiving the tubular members.

A plurality of splice tubes ay be secured together in parallel and placed within the crimp dies. In one embodiment, the splice tubes are small, thin walled hypo-tubes having a predetermined diameter and length. The splice tubes may be fabricated in staggered lengths such that the ends are flared to provide a lead-in. Arranged splice tubes are laid in the crimp dies and heated using a predetermined heat source operatively coupled to the crimp dies via leads. The heat source may be of any type configured to pass an electric current or voltage through the crimp dies and to the splice tubes. Once the splice tubes are heated, ends of mating optical fibers are inserted and optically contact each other. Thereafter, the crimping dies are compressed together. The crimping device compresses the splice tubes and deforms them about the optical fibers, forming a compressive load and maintaining a splice point.

In an exemplary mode of operation, a field technician first locates a desired splice point. Thereafter, the technician strips and cleaves the ends of opposing optical fibers that are to be spliced together. The technician places a number of splice tubes corresponding to the number of splices into crimp dies of a crimping device. The tubes are maintained by alignment features or grooves. A heat source heats the tubes until they reach a semi-molten state. Once semi-molten, opposing ends of the optical fibers to be spliced are inserted into the tubes until they contact. The fibers are held in place when as crimp dies of the crimping device are compressed against the tubes. Thereafter, the portion of a tube at which the splice point is desired is compressed, such that the tube deforms about the mating ends of the optical fibers. The optical fibers, likewise, deform such that a compressive load is maintained about the mating ends.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof.

### BRIEF DESCRIPTION OF THE DRAWINGS

These and other features, aspects and advantages of the present invention are better understood when the following detailed description of the invention is read with reference to the accompanying drawings, in which:

FIG. 1 is a cross-sectional view of a bend performance optical fiber suitable for use with the present invention;

FIG. 2 is a representational view of the bend performance optical fiber of FIG. 1;

FIG. 3 is a perspective view of a crimping device in a pre-compressed state and having a plurality of crimp dies with a plurality of splice tubes disposed thereon;

FIG. 4 is a partial cross-sectional view of the crimping device of FIG. 3 shown in a pre-compressed state;

FIG. 5 is a perspective view of a crimping device in a compressed state; and

FIG. 6 is a partial cross-sectional view of the crimping device of FIG. 5.

### DETAILED DESCRIPTION OF THE PREFERRED EMBODIMENTS

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings.

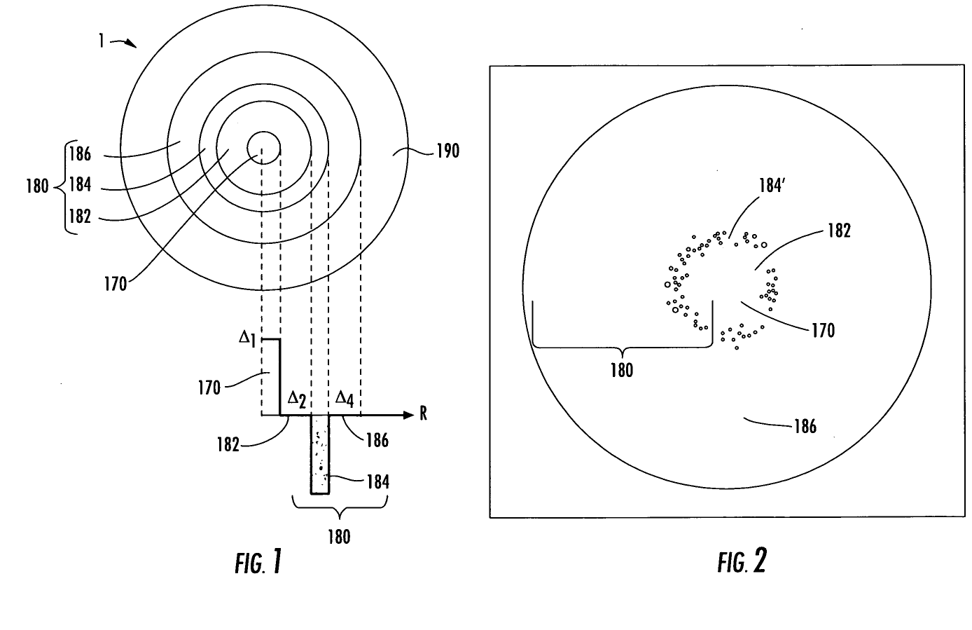

In the embodiments described below, methods and apparatus for splicing optical fibers via compression are provided. While this description discusses the invented method and apparatus for use with examples of bend performance optical fiber, it is to be understood that other suitable optical fiber types may be employed including, but not limited to, single mode, multi-mode, bend performance fiber, bend optimized fiber, bend insensitive optical fiber, micro-structured optical fiber, and nano-structured optical fiber, among others. Examples of micro-structured and nano-strucutred optical fibers are available from Corning, Inc of Corning, N.Y., and are described in FIGS. 1-2 and this description. Referring now to FIG. 1, one example of a bend performance optical fiber 1 suitable for use in the present invention is provided. The fiber is advantageous in that it allows aggressive bending while optical attenuation remains extremely low. As shown, bend performance optical fiber 1 is an optical fiber having a core region and a cladding region surrounding the core region, the cladding region comprising an annular hole-containing region comprised of non-periodically disposed holes such that the optical fiber is capable of single mode transmission at one or more wavelengths in one or more operating wavelength ranges. The core region and cladding region provide improved bend resistance, and single mode operation at wavelengths preferably greater than or equal to 1500 nm, in some embodiments also greater than about 1310 nm, in other embodiments also greater than 1260 nm. The optical fibers provide a mode field at a wavelength of 1310 nm preferably greater than 8.0 microns, more preferably between about 8.0 and 10.0 microns. In preferred embodiments, optical fiber disclosed herein is thus single-mode transmission optical fiber.

In some embodiments, the optical fibers disclosed herein comprises a core region disposed about a longitudinal centerline, and a cladding region surrounding the core region, the cladding region comprising an annular hole-containing region comprised of non-periodically disposed holes, wherein the annular hole-containing region has a maximum radial width of less than 12 microns, the annular hole-containing region has a regional void area percent of less than about 30 percent, and the non-periodically disposed holes have a mean diameter of less than 1550 nm.

By “non-periodically disposed” or “non-periodic distribution”, it will be understood to mean that when one takes a cross-section (such as a cross-section perpendicular to the longitudinal axis) of the optical fiber, the non-periodically disposed holes are randomly or non-periodically distributed across a portion of the fiber. Similar cross sections taken at different points along the length of the fiber will reveal different cross-sectional hole patterns, i.e., various cross-sections will have different hole patterns, wherein the distributions of holes and sizes of holes do not match. That is, the holes are non-periodic, i.e., they are not periodically disposed within the fiber structure. These holes are stretched (elongated) along the length (i.e. in a direction generally parallel to the longitudinal axis) of the optical fiber, but do not extend the entire length of the entire fiber for typical lengths of transmission fiber.

For a variety of applications, it is desirable for the holes to be formed such that greater than about 95% of and preferably all of the holes exhibit a mean hole size in the cladding for the optical fiber which is less than 1550 nm, more preferably less than 775 nm, most preferably less than 390 nm. Likewise, it is preferable that the maximum diameter of the holes in the fiber be less than 7000 nm, more preferably less than 2000 nm, and even more preferably less than 1550 nm, and most preferably less than 775 nm. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes. The hole number, mean diameter, max diameter, and total void area percent of holes can all be calculated with the help of a scanning electron microscope at a magnification of about 800× and image analysis software, such as ImagePro, which is available from Media Cybernetics, Inc. of Silver Spring, Md., USA.

The optical fibers disclosed herein may or may not include germania or fluorine to also adjust the refractive index of the core and or cladding of the optical fiber, but these dopants can also be avoided in the intermediate annular region and instead, the holes (in combination with any gas or gases that may be disposed within the holes) can be used to adjust the manner in which light is guided down the core of the fiber. The hole-containing region may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes.

In one set of embodiments, the core region includes doped silica to provide a positive refractive index relative to pure silica, e.g. germania doped silica. The core region is preferably hole-free. As illustrated in FIG. 1, in some embodiments, the core region 170 comprises a single core segment having a positive maximum refractive index relative to pure silica Δ₁ in %, and the single core segment extends from the centerline to a radius R₁. In one set of embodiments, 0.30%<Δ₁<0.40%, and 3.0 μm<R₁<5.0 μm. In some embodiments, the single core segment has a refractive index profile with an alpha shape, where alpha is 6 or more, and in some embodiments alpha is 8 or more. In some embodiments, the inner annular hole-free region 182 extends from the core region to a radius R₂, wherein the inner annular hole-free region has a radial width W12, equal to R2−R1, and W12 is greater than 1 μm. Radius R2 is preferably greater than 5 μm, more preferably greater than 6 μm. The intermediate annular hole-containing region 184 extends radially outward from R2 to radius R3 and has a radial width W23, equal to R3−R2. The outer annular region 186 extends radially outward from R3 to radius R4. Radius R4 is the outermost radius of the silica portion of the optical fiber. One or more coatings may be applied to the external surface of the silica portion of the optical fiber, starting at R4, the outermost diameter or outermost periphery of the glass part of the fiber. The core region 170 and the cladding region 180 are preferably comprised of silica. The core region 170 is preferably silica doped with one or more dopants. Preferably, the core region 170 is hole-free. The hole-containing region 184 has an inner radius R2 which is not more than 20 μm. In some embodiments, R2 is not less than 10 μm and not greater than 20 μm. In other embodiments, R2 is not less than 10 μm and not greater than 18 μm. In other embodiments, R2 is not less than 10 μm and not greater than 14 μm. Again, while not being limited to any particular width, the hole-containing region 184 has a radial width W23 which is not less than 0.5 μm. In some embodiments, W23 is not less than 0.5 μm and not greater than 20 μm. In other embodiments, W23 is not less than 2 μm and not greater than 12 μum. In other embodiments, W23 is not less than 2 μm and not greater than 10 μm.

Such fiber can be made to exhibit a fiber cutoff of less than 1400 nm, more preferably less than 1310 nm, a 20 mm macrobend induced loss at 1550 nm of less than 1 dB/turn, preferably less than 0.5 dB/turn, even more preferably less than 0.1 dB/turn, still more preferably less than 0.05 dB/turn, yet more preferably less than 0.03 dB/turn, and even still more preferably less than 0.02 dB/turn, a 12 mm macrobend induced loss at 1550 nm of less than 5 dB/turn, preferably less than 1 dB/turn, more preferably less than 0.5 dB/turn, even more preferably less than 0.2 dB/turn, still more preferably less than 0.01 dB/turn, still even more preferably less than 0.05 dB/turn, and a 8 mm macrobend induced loss at 1550 nm of less than 5 dB/turn, preferably less than 1 dB/turn, more preferably less than 0.5 dB/turn, and even more preferably less than 0.2 dB-turn, and still even more preferably less than 0.1 dB/turn.

One example of a suitable fiber is illustrated in FIG. 2, and comprises a core region that is surrounded by a cladding region that comprises randomly disposed voids which are contained within an annular region spaced from the core and positioned to be effective to guide light along the core region. Other optical fibers and micro-structured fibers may be used in the present invention. Additional description of micro-structured fibers used in the present invention are disclosed in pending U.S. patent application Ser. No. 11/583,098 filed Oct. 18, 2006; and, Provisional U.S. patent application Ser. Nos. 60/817,863 filed Jun. 30, 2006; 60/817,721 filed Jun. 30, 2006; 60/841,458 filed Aug. 31, 2006; and 60/841,490 filed Aug. 31, 2006; all of which are assigned to Corning Incorporated; and incorporated herein by reference.

Another example of bend performance fiber that may be used in the present invention is bend resistant multimode optical fiber also available from Corning, Inc, that comprises a graded-index core region and a cladding region surrounding and directly adjacent to the core region, the cladding region comprising a depressed-index annular portion comprising a depressed relative refractive index, relative to another portion of the cladding (which preferably is silica which is not doped with an index of refraction altering dopant such as germania or fluorine). Preferably, the refractive index profile of the core has a parabolic shape. The depressed-index annular portion may comprise glass comprising a plurality of holes, fluorine-doped glass, or fluorine-doped glass comprising a plurality of holes. The depressed index region can be adjacent to or spaced apart from the core region.

In some embodiments that comprise a cladding with holes, the holes can be non-periodically disposed in the depressed-index annular portion. By “non-periodically disposed” or “non-periodic distribution”, we mean that when viewed in cross section (such as a cross section perpendicular to the longitudinal axis) of the optical fiber, the non-periodically disposed holes are randomly or non-periodically distributed across the hole containing region. Cross sections taken at different points along the length of the fiber will reveal different cross-sectional hole patterns, i.e., various cross sections will have different hole patterns, wherein the distributions of holes and sizes of holes do not match. That is, the voids or holes are non-periodic, i.e., they are not periodically located within the fiber structure. These holes are stretched (elongated) along the length (i.e. parallel to the longitudinal axis) of the optical fiber, but do not extend the entire length of the entire fiber for typical lengths of transmission fiber.

The multimode optical fiber disclosed herein exhibits very low bend induced attenuation, in particular very low macrobending. In some embodiments, high bandwidth is provided by low maximum relative refractive index in the core, and low bend losses are also provided. In some embodiments, the core radius is large (e.g. greater than 20 μm), the core refractive index is low (e.g. less than 1.0%), and the bend losses are low. Preferably, the multimode optical fiber disclosed herein exhibits a spectral attenuation of less than 3 dB/km at 850 nm.

The numerical aperture (NA) of the optical fiber is preferably greater than the NA of the optical source directing signals into the fiber; for example, the NA of the optical fiber is preferably greater than the NA of a VCSEL source. The bandwidth of the multimode optical fiber varies inversely with the square of Δ1_{MAX}. For example, a multimode optical fiber with Δ1_{MAX} of 0.5% can yield a bandwidth 16 times greater than an otherwise identical multimode optical fiber except having a core with Δ1_{MAX} of 2.0%.

In some embodiments, the core extends radially outwardly from the centerline to a radius R1, wherein 12.5≦R1≦40 microns. In some embodiments, 25≦R1≦32.5 microns, and in some of these embodiments, R1 is greater than or equal to about 25 microns and less than or equal to about 31.25 microns. The core preferably has a maximum relative refractive index, less than or equal to 1.0%. In other embodiments, the core has a maximum relative refractive index, less than or equal to 0.5%. Such multimode fibers preferably exhibit a 1 turn 10 mm diameter mandrel attenuation increase of no more than 1.0 dB, preferably no more than 0.5 dB, more preferably no more than 0.25 dB, even more preferably no more than 0.1 dB, and still more preferably no more than 0.05 dB, at all wavelengths between 800 and 1400 nm.

If non-periodically disposed holes or voids are employed in the depressed index annular region, it is desirable for the holes to be formed such that greater than 95% of and preferably all of the holes exhibit a mean hole size in the cladding for the optical fiber which is less than 1550 nm, more preferably less than 775 nm, most preferably less than about 390 nm. Likewise, it is preferable that the maximum diameter of the holes in the fiber be less than 7000 nm, more preferably less than 2000 nm, and even more preferably less than 1550 nm, and most preferably less than 775 nm. In some embodiments, the fibers disclosed herein have fewer than 5000 holes, in some embodiments also fewer than 1000 holes, and in other embodiments the total number of holes is fewer than 500 holes in a given optical fiber perpendicular cross-section. Of course, the most preferred fibers will exhibit combinations of these characteristics. Thus, for example, one particularly preferred embodiment of optical fiber would exhibit fewer than 200 holes in the optical fiber, the holes having a maximum diameter less than 1550 nm and a mean diameter less than 775 nm, although useful and bend resistant optical fibers can be achieved using larger and greater numbers of holes. The hole number, mean diameter, max diameter, and total void area percent of holes can all be calculated with the help of a scanning electron microscope at a magnification of about 800X and image analysis software, such as ImagePro, which is available from Media Cybernetics, Inc. of Silver Spring, Md., USA.

The optical fiber disclosed herein may or may not include germania or fluorine to also adjust the refractive index of the core and or cladding of the optical fiber, but these dopants can also be avoided in the intermediate annular region and instead, the holes (in combination with any gas or gases that may be disposed within the holes) can be used to adjust the manner in which light is guided down the core of the fiber. The hole-containing region may consist of undoped (pure) silica, thereby completely avoiding the use of any dopants in the hole-containing region, to achieve a decreased refractive index, or the hole-containing region may comprise doped silica, e.g. fluorine-doped silica having a plurality of holes.

The numerical aperture (NA) of the optical fiber is preferably greater than the NA of the optical source directing signals into the fiber; for example, the NA of the optical fiber is preferably greater than the NA of a VCSEL source. The bandwidth of the multimode optical fiber varies inversely with the square of Δ1_{MAX}. For example, a multimode optical fiber with Δ1_{MAX} of 0.5% can yield a bandwidth 16 times greater than an otherwise identical multimode optical fiber except having a core with Δ1_{MAX} of 2.0%.

In some embodiments, the core outer radius, R₁, is preferably not less than 12.5 μm and not more than 40 μm, i.e. the core diameter is between about 25 and 80 μm. In other embodiments, R1>20 microns; in still other embodiments, R1>22 microns; in yet other embodiments, R1>24 microns.

Methods of making such optical fibers with holes is described in U.S. patent application Ser. No. 11/583098, filed Oct. 18, 2006, and U.S. Provisional Patent No. 60/879,164, filed Jan. 8, 2007, the specifications of which are hereby incorporated by reference in their entirety.

Referring to FIGS. 3-6, a crimping device 10 is provided. The crimping device 10 is preferably made of a lightweight and rigid material, such as aluminum, steel, thermoplastic or plastic. The crimping device 10 is provided with a plurality of crimp dies 12 operable for supporting and housing a plurality of splice tubes 14. It will be understood by those skilled in the art that any number of splice tubes may be used. The plurality of crimp dies 12 may be constructed using conductive material. Further, the crimp dies 12 may be attached to a support block and a corresponding press block. Each crimp die 12 is provided with an alignment geometry feature 16 operable for maintaining the splice tubes 14 in a precise orientation and spacing. The plurality of crimp dies may have any shape including generally rectangular and elongated in the lengthwise dimension. Leads 22 are formed along selected sides of at least two of the crimp dies for permitting a heat source 100 to be connected.

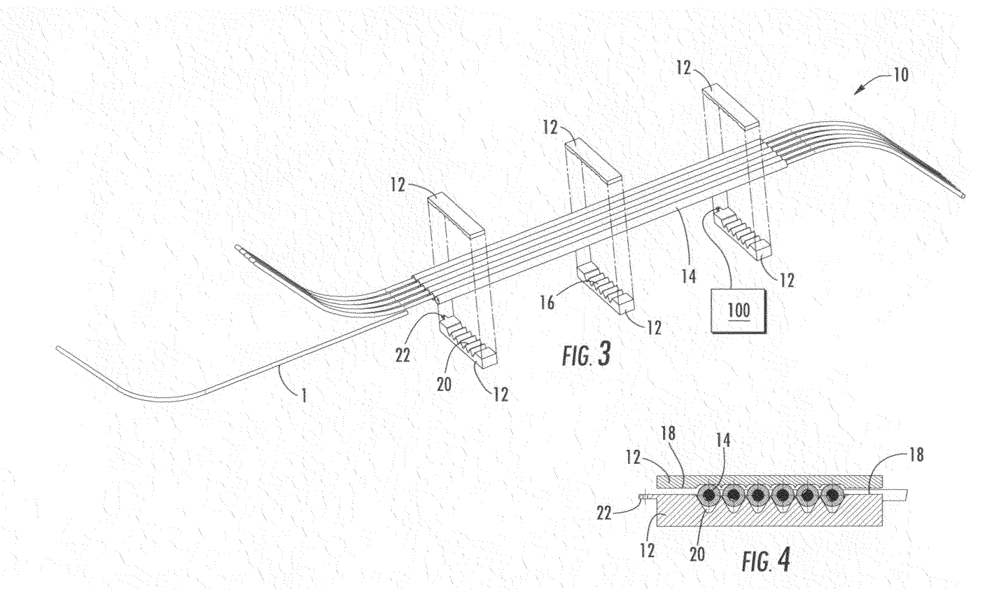

The alignment geometry feature 16 is located substantially intermediate crimp dies 12 and extends widthwise along the entirety of surface 18. Further, in the exemplary embodiment shown, the alignment geometry feature 16 includes a plurality of grooves or channels 20 operable for receiving the splice tubes 14. As best shown in FIGS. 4 and 6, the channels 20 are numbered, sized, and shaped to receive the splice tubes in a 6 fiber application. However, it will be appreciated by those skilled in the art that the number and size of the channels may vary to accommodate other optical fiber applications. Further, it will be appreciated by those skilled in the art that the shape of the channels 20 may vary. By way of example, and without limitation, the channels 20 may have the cross-sectional contour of substantially the letter V (FIG. 3), as in a conventional V-shaped groove, or substantially the letter U. The channels 20 may have any other cross-sectional contours insofar as the splice tubes 14 can be accurately positioned in the crimp dies 12. As shown, the channels 20 extend parallel to one another.

In specific embodiments, the splice tubes are hypotubes. As is known in the art, a hypotube is a hollow metal tube of very small diameters, of the type typically used in manufacturing hypodermic needles. Splice tubes may comprise any type of hollow tube, however, and are not limited only to tubes considered in the art to be hypotubes.

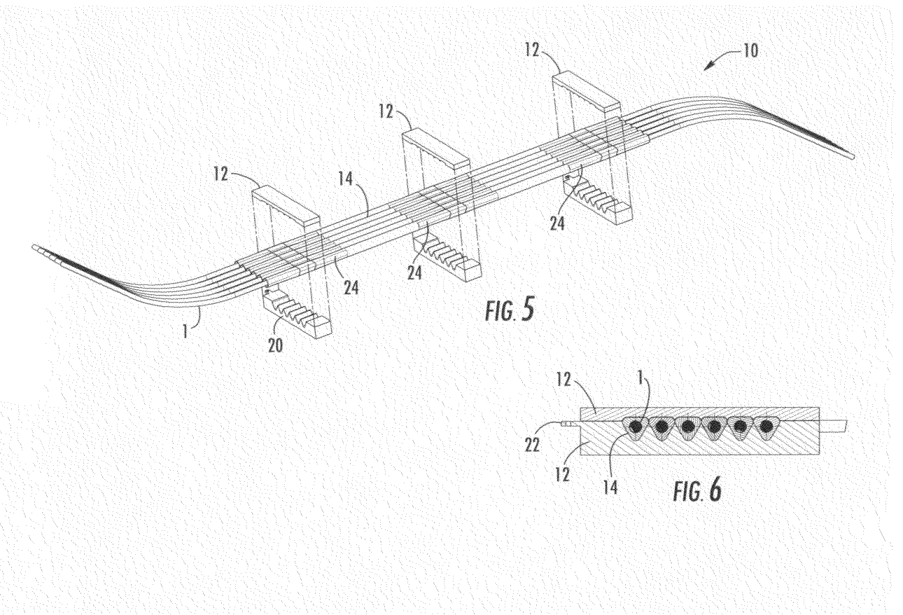

The splice tubes described herein may comprise any suitable material known in the art, such as but not limited to nickel-titanium alloys, cobalt-chromium alloys such as elgiloy, and titanium. However, in the exemplary embodiments described herein, the splice tubes are stainless steel. As shown in FIGS. 3 and 5, a series of splice tubes 14 are presented secured together and placed within the crimp dies 12. It will be understood by those skilled in the art that the manner of securing the splice tubes 14 together may vary. Suitable manners of securing the splice tubes may include welding, gluing, tying, or the like. In exemplary embodiments, the dimensions of a splice tube may be 12 mm in length, 0.13 mm inner diameter and 0.250 mm outer diameter. The splice tubes are preferably fabricated or arranged in staggered lengths (FIG. 3) such that the ends of the splice tubes may have clearance for flaring or providing a small concial lead-in. Once the splice tubes are secured together, they are laid in the crimp dies 12.

The splice tubes 14 are then heated using a heat source 100. As stated above, the heat source is removably attached to the crimp dies 12 via the leads 22. The heat source may be any type of heat source including, but not limited to, a battery, such that an electrical current or voltage may be passed through the crimp dies 12 and into the splice tubes 14. The heat source is operable for heating the splice tubes 14 such that they transform into a filament, as in that of a light bulb, and reach a semi-molten state depending on the amount of current applied. The splice tubes 14 are capable of reaching the semi-molten state by virtue of their thin walls. Once the current is applied and the splice tubes 14 reach a semi-molten state, ends of optical fiber(s) 1 are inserted into the splice tubes 14 until they abut one another. Once the optical fibers 1 abut, the crimping dies 12 are compressed together by a crimping actuator or by another tool of a technician. The crimping device 10 crimps and compresses the splice tubes 14 at multiple points 24 as shown in FIG. 5. In exemplary embodiments, the crimping device 10 is configured such that the exterior points of the splice tubes 14 and the optical fibers 1 are crimped or compressed first followed by the center. The staged crimping or compressing along with the application of heat to the overall assembly forms a permanent compressive load on the splice point (the area in the tubular members where the opposing ends of the optical fibers abut) 24 as shown in FIG. 5 and will maintain this compressive load over outside temperature variations.

In an exemplary mode of operation, a field technician first locates a desired splice point. Thereafter, the technician strips and cleaves the ends of opposing optical fibers 1 which are to be spliced together. The technician places a number of splice tubes 14 corresponding to the number of splices into a plurality of crimp dies 12 of a crimping device 10 (FIG. 4). The splice tubes are maintained in a precise position by the alignment geometry features 20 or grooves. Once the splice tubes are properly positioned, the technician actuates a heat source such that the splice tubes are heated until they reach a semi-molten state. Upon reaching a semi-molten state, opposing ends of the optical fibers 1 are inserted until they abut one another. The ends of the optical fibers are held in place as compressed is applied to the splice tubes to deform them. The crimping device 10 is then removed and a permanent compression splice is achieved.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

1. A method for compression splicing optical fibers, comprising:
providing a first optical fiber defining a first end and a second optical fiber defining a second end;
providing a deformable splice tube;
placing the deformable splice tube within a crimping device operable to deform the deformable splice rube;
connecting a heat source to a lead of the crimping device to heat the deformable splice tube;
inserting the first and second ends of the first and second optical fibers into the deformable splice tube until the first and second ends contact; and
applying compression to the crimping device to apply compression to the heated splice tube to deform the splice tube and maintain the first and second ends in contact.

2. The method of claim 1, wherein the first and the second ends are inserted prior to heating the deformable splice tube.

3. The method of claim 1, wherein the splice tube is deformed using a crimping device having a predetermined geometry.

4. The method of claim 1, wherein the crimping device defines features for aligning a plurality of deformable splice tubes.

5. The method of claim 4, wherein the features are channels having a cross-sectional contour that is generally V-shaped.

6. The method of claim 1, wherein the deformable splice tube is a hypotube.

7. The method of claim 1, wherein the deformable splice tube comprises stainless steel.

8. (canceled)

9. The method of claim 1, wherein the first and the second optical fibers comprise a core region and a cladding region surrounding the core region, the cladding region comprising an annular hole-containing region comprised of non-periodically disposed holes such that the optical fibers are capable of single mode or multi-mode transmission at one or more wavelengths in one or more operating wavelength ranges.

10. An apparatus for compression splicing optical fibers, comprising:
a deformable splice tube defining a first end for receiving a first optical fiber and a second end for receiving a second optical fiber; and
a compression device comprising a first part defining a surface having a splice tube alignment geometry in contact with the splice tube, and a second part defining a surface having a geometry for applying the compressive force, wherein the compression device is operable to be coupled to a heat source to operatively couple the heat source to the deformable splice tube, and further operable to apply a compressive force to the splice tube to deform the splice tube after the splice tube is heated by the heat source.

11. (canceled)

12. The apparatus of claim 10, wherein the compression device further comprises a lead for connecting to the heat source.

13. The apparatus of claim 10, wherein the heat source is a battery.

14. The apparatus of claim 10, wherein the splice tube defines at least one flared end.

15. The apparatus of claim 10, wherein the compression device comprises a first component and a second component for receiving the splice tube therebetween.

16. The apparatus of claim 10, wherein the compression device is stainless steel.

17. The apparatus of claim 10, wherein the splice tube is a hypotube.

18. The method of claim 1, wherein the first and the second ends are inserted after heating the deformable splice tube.

19. A method for compression splicing optical fibers, comprising:
providing a first optical fiber defining a first end and a second optical fiber defining a second end;
providing a deformable splice tube;
aligning the deformable splice tube within a crimping device defining features for aligning a plurality of deformable splice tubes;
heating the deformable splice tube with a heat source;
inserting the first and second ends of the first and second optical fibers into the deformable splice tube until the first and second ends contact; and
applying compression to the crimping device to apply compression to the heated splice tube to deform the splice tube and maintain the first and second ends in contact.

20. The method of claim 19, wherein the features are channels having a cross-sectional contour that is generally V-shaped.
